(19) United States
(12) Patent Application Publication
(10) Pub. No.: US 2026/0351432 A1
(43) Pub. Date: Nov. 5, 2026

(54) MULTI-BEAM SYSTEMS WITH PLASMA WINDOWS AND A CENTRAL TARGET CHAMBER

(71) Applicant: Shine Technologies, LLC, Janesville, WI (US)

(72) Inventors: Joshua Blatz, Janesville, WI (US); Craig Jacobson, Janesville, WI (US); Preston Barrows, Janesville, WI (US); Todd Kile, Janesville, WI (US); Tye Gribb, Janesville, WI (US); Lucas Jacobson, Janesville, WI (US)

(73) Assignee: Shine Technologies, LLC, Janesville, WI (US)

(21) Appl. No.: 19/119,973

(22) PCT Filed: Oct. 11, 2023
(86) PCT No.: PCT/US2023/034963

§ 371 Date: Apr. 10, 2025

Related U.S. Application Data
(60) Provisional application No. 63/415,066, filed on Oct. 11, 2022.

(51) Int. Cl. G21B 1/19

(52) U.S. Cl. CPC G21B 1/19

(57) ABSTRACT

A beam accelerator system that includes a plurality of beamlines each comprising a beam accelerator and a low pressure chamber, wherein the beam accelerator is configured to generate a charged particle beam; a central target chamber coupled to each of the plurality of beamlines such that the plurality of beamlines direct charged particle beams into the central target chamber; and a plurality of plasma window assemblies positioned in openings of the central target chamber to form an interface between each beamline and the central target chamber, thereby providing a pressure barrier between the central target chamber and each of the plurality of beamlines.

### STATEMENT REGARDING FEDERALLY SPONSORED RESEARCH AND DEVELOPMENT

The present disclosure was developed with Government support under Contract No. DE-AR0001377 awarded by the United States Department of Energy. The Government has certain rights in the present disclosure.

### BACKGROUND

The present disclosure generally beam accelerator systems, such as, for example, a gaseous-target neutron generation system that includes one or more plasma window systems.

### SUMMARY

According to one embodiment of the present disclosure a beam accelerator system includes a plurality of beamlines each having a beam accelerator and a low pressure chamber, wherein the beam accelerator is configured to generate an ion beam, a central target chamber coupled to each of the plurality of beamlines such that the plurality of beamlines direct ion beams into the central target chamber; and a plurality of plasma window assemblies positioned in openings of the central target chamber to form an interface between each beamline and the central target chamber, thereby providing a pressure barrier between the central target chamber and each of the plurality of beamlines.

According to another embodiment of the present disclosure, a method includes generating plasma in a plasma channel of each of a plurality of plasma window assemblies, wherein each plasma window assemblies positioned in openings of a central target chamber and directing a plurality of ion beams generated along a plurality of beamlines through the plasma of the plurality of plasma window assemblies and into the central target chamber, wherein the central target chamber houses a target gas and each ion beam interacts with the target gas to produce neutrons via a fusion reaction. Each of the plurality of beamlines includes a beam accelerator and a low pressure chamber and the central target chamber is coupled to each of the plurality of beamlines by the plurality of plasma window assemblies, and the plasma generated by each plasma window assembly forms an interface between the plurality of beamlines and the central target chamber, thereby providing a pressure barrier between the central target chamber and each of the plurality of beamlines.

According to yet another embodiment of the present disclosure, a beam accelerator system includes a target chamber with a first opening and a second opening, a first beamline comprising a first beam accelerator and a first low pressure chamber, wherein the first beam accelerator is configured to generate a first charged particle beam that enters the target chamber through the first opening along a first beamline axis; a second beamline comprising a second beam accelerator and a second low pressure chamber, wherein the second beam accelerator is configured to generate a second charged particle beam that enters the target chamber through the second opening along a second beamline axis; a first plasma window assembly positioned at the first opening of the target chamber to form an interface between the first beamline and the target chamber, thereby providing a pressure barrier between the target chamber and the first low pressure chamber; and a second plasma window assembly positioned at the second opening of the target chamber to form an interface between the second beamline and the target chamber, thereby providing a pressure barrier between the target chamber and the second low pressure chamber, wherein the first plasma window assembly and the second plasma window assembly each comprise an anode; a cathode pair; a plurality of plates positioned between the anode and the cathode pair, wherein each plate comprises an aperture that is aligned with an aperture in one or more adjacent plates to form a plasma channel; the cathode pair of the first plasma window assembly is oriented orthogonal to the first beamline axis; and the cathode pair of the second plasma window assembly is oriented orthogonal to the second beamline axis.

Additional features and advantages will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a gaseous target neutron generation system according to embodiments disclosed and described herein;

FIG. 2A schematically depicts an anode, plasma window, cathode housing, and cathodes according to embodiments disclosed and described herein;

FIG. 2B schematically depicts a cross-section of the anode, plasma window, cathode housing, and cathodes according to embodiments disclosed and described herein;

FIG. 3 schematically depicts a cross-section of an anode, plasma window, and cathode housing according to embodiments disclosed and described herein;

FIG. 4 schematically depicts a front view of a plate having two parallel cooling channels according to embodiments disclosed and described herein;

FIG. 5A graphically depicts linear neutron source profiles of ion beams directed into gas target chambers of FIGS. 1-4 having a range of target gas pressures, according to one or more embodiments disclosed and described herein;

FIG. 5B graphically depicts linear neutron source profiles of ion beams directed into gas target chambers of FIGS. 1-4 having another range of target gas pressures, according to one or more embodiments disclosed and described herein;

FIG. 6A schematically depicts a beam accelerator system comprising two beamlines positioned end-to-end with a central target chamber, according to one or more embodiments disclosed and described herein;

FIG. 6B schematically depicts another beam accelerator system comprising two beamlines positioned end-to-end with a central target chamber, according to one or more embodiments disclosed and described herein;

FIG. 7 graphically depicts a linear neutron source profile of ion beams directed into gas target chambers of FIG. 6A having a range of target gas pressures, according to one or more embodiments disclosed and described herein;

FIGS. 8A and 8B schematically depict neutrons flux maps corresponding to the linear neutron source profiles of FIG. 7, according to one or more embodiments disclosed and described herein;

FIG. 8B schematically depict additional neutrons flux maps corresponding to the linear neutron source profiles of FIG. 7, according to one or more embodiments disclosed and described herein;

FIG. 9A is a schematic depiction of a beam accelerator system having multiple beamlines arranged in a radial array, according to one or more embodiments disclosed and described herein;

FIG. 9B is a schematic depiction of another beam accelerator system having multiple beamlines arranged in a radial array, according to one or more embodiments disclosed and described herein;

FIG. 9C is a schematic depiction of yet another beam accelerator system having multiple beamlines arranged in a radial array, according to one or more embodiments disclosed and described herein;

FIG. 10 graphically depicts mean displacement rate as a function of number of ion beams entering a central target chamber with distance above plane as a parameter, according to one or more embodiments disclosed and described herein;

FIG. 11 graphically depicts usable sample volume at a variety of displacement rates as a function of the number of ion beams for a single beam accelerator system, according to one or more embodiments shown and described herein; and

FIG. 12, schematically depicts a beam accelerator system having two central target chambers stacked together, according to one or more embodiments shown and described herein.

### DETAILED DESCRIPTION

Reference will now be made in detail to embodiments of beam accelerator systems that include plasma windows, embodiments of which are illustrated in the accompanying drawings. Whenever possible, the same reference numerals will be used throughout the drawings to refer to the same or like parts.

The beam accelerator systems described here may be used to generate neutrons via fusion for a variety of purposes, such as medical isotope production, nuclear waste transmutation, fusion energy generation, and for use as a fusion-prototypic neutron source (FPNS). A FPNS can generate neutrons at high flux in the 14.1 MeV spectrum to emulate the neutron-induced damage of a deuterium-tritium reaction on materials. Thus, FPNS could be used to qualify materials and electronic components for use in areas of fusion power development. Indeed, the materials that will be used in fusion reactors will be subjected to intense fluxes of 14.1 MeV neutrons during operation from the deuterium-tritium (DT) reaction. This will occur in multiple locations within a fusion reactor, such as the plasma-facing and inner wall components of a vacuum vessel and the structural materials within the tritium breeding blanket. Independent of the technology used to achieve fusion, the materials used are expected to incur doses of 20 to 50 displacements per atom (dpa) per full power year (fpy) at temperatures ranging from 300 °C to 1000 °C. Additionally, conventional tritium breeding techniques mix breeding materials with structural materials. Therefore, the integrity of the solid breeder materials must also be tested under the same conditions described for structural materials. Requirements for an FPNS were defined in the Summary Report on the Fusion Prototypic Neutron Source Workshop (labeled Guideline in Table 1) and further refined in the Summary Report on the Refined User Requirements for U.S. Fusion Prototypic Neutron Source (updates labeled Augmentation in Table 1). Each are summarized below in Table 1.

TABLE 1

| Parameter | Guideline | Augmentation |
|---|---|---|
| Damage rate | 8 dpa/fpy to 11 dpa/fpy | Time averaged during beam-on |
| | | period, integrated over irradiation |
| | | time. Required for >70% of |
| | | sample volume. |
| Neutron energy spectrum | ~10 appm He/dpa (Fe) | ~40 appm H/dpa (Fe) |
| Sample volume in high | ≥50 cm³ | Accommodation of in situ control |
| flux region | | and measurement capabilities |
| Temperature range | 300 °C to 1000 °C | |
| Temperature control | Three independently | Maintain 5% of target |
| | monitored and controlled | temperature (Kelvin) at a |
| | regions | reference point in each |
| | | temperature zone |
| Flux gradient | ≤20%/cm in the plane of the | Spatial variation <10% along 6 |
| | sample | mm length in beam-normal plane |
| | | within at least 70% of all |
| | | temperature zones |

Neutrons generated by a DT reaction (DT neutrons) are particularly desirable for testing since they produce the desired ratio among hydrogen production rate, helium production rate, and displacement rates for an FPNS. For 14.1 MeV neutrons incident upon an iron target, the helium production rate to displacement rate ratio is 19.1 atomic parts per million (appm)/displacements per atom (dpa), and the hydrogen production rate to displacement rate ratio is 73.1 appm/dpa. As neutron energy is reduced from 14.1 MeV, hydrogen and helium production cross sections drop off much more quickly than displacement cross sections. As such, DT neutrons are preferred over fission neutrons which are mostly below 2 MeV and with near zero population at 10 MeV.

The beam accelerator systems described herein are gaseous target neutron generation systems that include one or more plasma windows that operate as a windowless vacuum barrier to separate a low-pressure beamline and a high-pressure gaseous target chamber. The plasma window allows for systems with an increased gaseous target pressure, a shortened target length, and an increased current delivered to the target (e.g., a target gas present in the target chamber), resulting in an increase of two or more orders of magnitude in accessible neutron flux compared to traditional beam accelerator systems increasing displacement rate. The present disclosure also contemplates beam accelerator systems with multiple beamlines to further increase displacement rate. In addition to performance improvements, the beam accelerator systems described herein offer a significant reduction in development time and costs when compared to a multi-national facility, such as the International Fusion Materials Irradiation Facility (IFMIF).

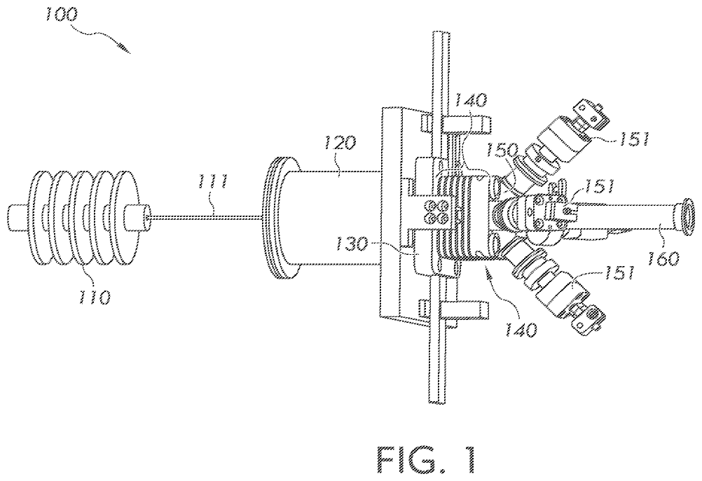

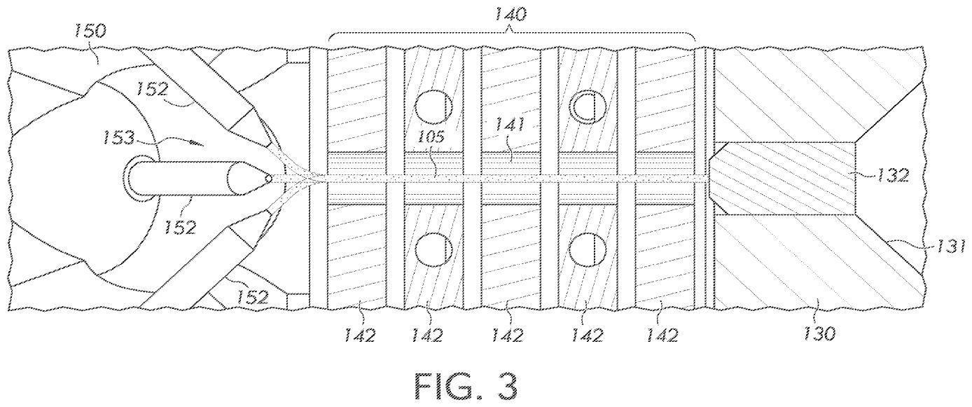

With reference now to FIG. 1, an embodiment of a beam accelerator system 100 is schematically depicted. The beam accelerator system 100 comprises a beam accelerator 110 that generates a charged particle beam 111 that is directed to a low-pressure chamber 120 (e.g., a beam accelerator region). In some embodiments, the beam accelerator 110 may comprise an ion accelerator that generates a high-energy ion beam. In other embodiments, the beam accelerator 110 may comprise an electron beam accelerator that generates an electron beam. In embodiments, the low-pressure chamber 120 is operated at a vacuum or near vacuum. The beam accelerator system 100 also comprises a target chamber 160 for housing a target gas, such as deuterium, tritium, helium, or argon. It should be understood that the beam accelerator system 100 depicted in FIGS. 1-3 is merely schematic and is not to scale.

In some embodiments, the beam accelerator system 100 operates by first extracting a beam of deuterium from the beam accelerator 110, which may comprise an electron cyclotron resonance (ECR) based ion source. The deuterium beam is accelerated via stepped electrostatic potentials such that a desired deuterium-tritium fusion cross-section is achieved when the deuterium beam enters the gaseous tritium target, located in the target chamber 160, generating neutrons via a fusion reaction. In some embodiments, the deuterium beam is focused through a gas-flow-restricting aperture that separates the beam acceleration region (e.g., the low-pressure chamber 120) from the target chamber 160.

One key to neutron generation is the ability to generate and maintain a large pressure gradient from the beam acceleration region (e.g., the low-pressure chamber 120) to the target chamber 160, which may be filled with tritium. The beam acceleration region (e.g., the low-pressure chamber 120) operates under high vacuum conditions, In contrast, the target chamber 160, where neutrons are generated, may operate at pressures over multiple powers of ten higher, for example, over a million times higher, to stop the deuterium beam over approximately one meter. Current beam accelerator systems accomplish this pressure differential through a series of differentially pumped stages in which each stage is separated by a gas-flow-restricting aperture that will allow the deuterium beam to pass but restricts gas flow from higher- to lower-pressure regions. The exhaust from each pumping stage is returned to the adjacent, higher-pressure stage.

Traditionally, such differentially pumped stages require large and expensive pumping infrastructure to maintain the low pressure required for the charged particles (e.g., ions or electrons) to be accelerated from the beam accelerator 110 while maximizing the pressure in the target chamber 160. Larger ion beam sizes and higher current ion beams require more pumping due to the conductance of the ion beam through a channel and into the target chamber 160. Therefore, the beam size and thus total yield of a system is limited by the diameter of the channel into the target chamber 160. Moreover, if the aperture is widened to allow more beam to pass, the gas flow from the high-pressure region to the low-pressure region would necessarily increase. This increase in gas flow would then reduce the pressure differential across the adjacent stages. Alternatively, if the diameter of the aperture were reduced, an observation of increased pressure differential would be seen. This reduction of aperture diameter would also require a reduction in beam current to make it possible to focus said beam into the now much smaller area.

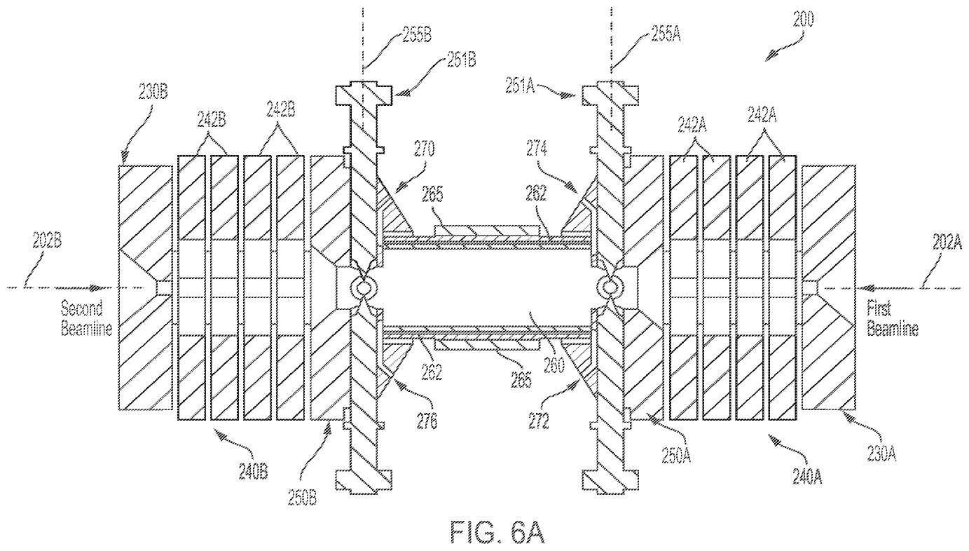

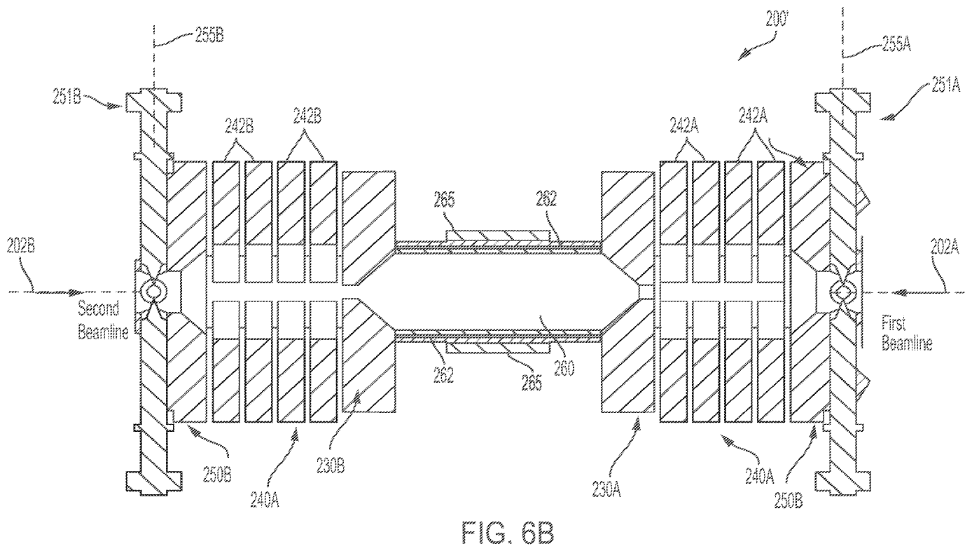

As depicted in FIGS. 1-3, the beam accelerator system 100 may include a plasma window 140 that operates as a windowless vacuum barrier to separate the low-pressure beam acceleration region (e.g., the low-pressure chamber 120) and the target chamber 160. The plasma window 140 allows for an increase the beam current of the ion beam and the gas pressure in the target chamber 160, thereby increasing neutron flux. Utilizing the plasma window 140 allows for a greater pressure reduction factor relative to traditional channels, facilitating the use of larger diameter and higher power ion beams. The gains from pressure reduction also reduce the total pumping cost due to the decrease in conductance and pumping hardware required to maintain the pressure differential. This change alone enables a four times reduction in length of the target chamber 160 and thus, a significant increase in neutron flux and displacement rate. The plasma window 140 also allows the aperture 410, through which the ion beam travels to reach the target chamber 160, to be widened, allowing for larger ion beams to be transported into the target chamber 160. These larger ion beams will allow for increased current and therefore also increase neutron flux. Moreover, as described in more detail below with respect to FIGS. 6-10, embodiments of beam accelerator systems are also contemplated having multiple beamlines (e.g., multiple beam accelerators 110 and low-pressure chambers 120 that operate as low-pressure beam accelerator regions) and multiple plasma windows, to further increase the neutron flux and displacement rate.

Referring still to FIGS. 1-3, the beam accelerator system 100 also comprises an anode 130 that is positioned adjacent and fluidly connected to the low-pressure chamber 120 and is separated from a cathode housing 150 by the plasma window 140. The plasma window 140 is adjacent and fluidly connected to both the anode 130 and the cathode housing 150. In embodiments, the anode 130 is an anode plate, which is a grounded plate, such as a grounded copper plate. The anode 130 comprises a nozzle 131 that is fluidly connected to the low-pressure chamber 120. The nozzle 131 is also fluidly connected to a channel 132 positioned in the anode 130. As will be discussed in more detail below, the nozzle 131 and the channel 132 in the anode 130 operate to funnel the ion beam from the low-pressure side of the beam accelerator system 100 to the plasma window 140. To this end, in one or more embodiments, the anode and/or the low-pressure chamber 120 are mounted to and fluidly connected with a pumping system.

The cathode housing 150 is configured to house a plurality of cathodes 151, which will be described in more detail below. The target chamber 160 and the cathode housing 150 are pressurized so that the cathode housing 150 is on a high-pressure side of the beam accelerator system 100, and the anode 130 is present on a low-pressure side (e.g., vacuum side) of the beam accelerator system 100. While the gases present in the target chamber 160 are prevented from flowing into the lower pressure low-pressure chamber 120 by the plasma window 140, gases generated by the beam accelerator 110 and those present in the low-pressure chamber 120 do not travel past the anode 130 and into the plasma window 140 or cathode housing 150 because of the pressure differential between the low-pressure side of the beam accelerator system 100 and the high-pressure side of the beam accelerator system 100.

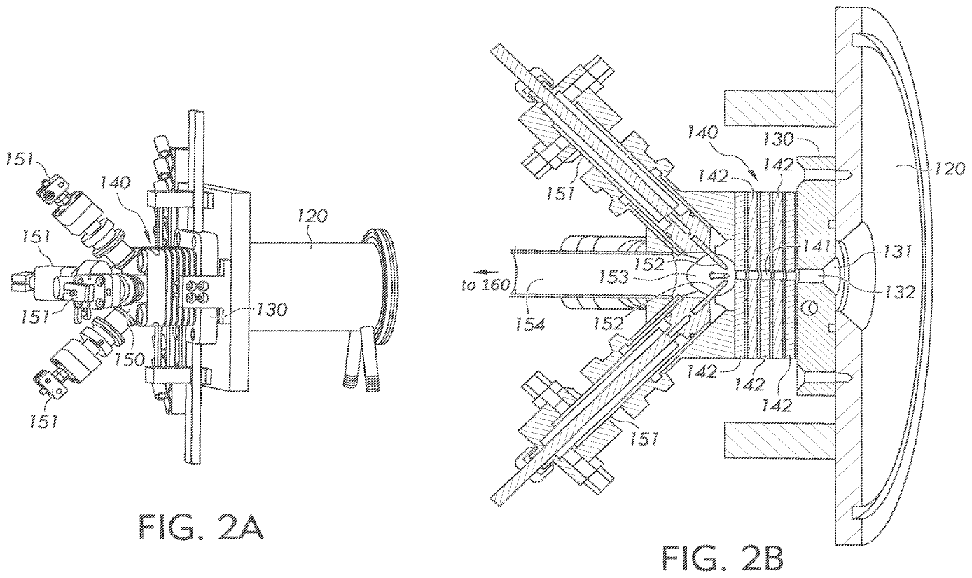

Referring now to FIGS. 2A-4, the plasma window 140 comprises a plurality of plates 142 that are adjacent and connected to one another. In some embodiments, the plasma window 140 comprises from four to eight plates 142, such as from 5 to 7 plates 142, or six plates 142. In the embodiment depicted in FIG. 2B, the plasma window 140 includes five adjacent plates 142 that are connected to one another and separate the anode 130 from the cathode housing 150. Each plate 142 of the plasma window 140 comprises an aperture 410 at or near the geometrical center of the plate 142. The aperture 410 (e.g. circular aperture) of each plate 142 is aligned around a central axis so that when the plurality of plates 142 are aligned and connected, the coaxial, circular apertures in the plates 142 form a plasma channel 141 where a plasma 105 (e.g., a viscous plasma) may be formed and through which the high-energy ion beam will travel from the anode 130 to the cathode housing 150. It should be appreciated that in embodiments the apertures in the plates 142 need not be perfectly circular and may be any shape that can accommodate the transmission of the high-energy ion beam. The plates 142 of the plasma window 140 are, in embodiments, electrically floating and are cooled with a fluid, such as water. By constructing the plates 142 to be electrically floating, the voltage gradient across the plasma channel 141 is not as steep as it would be if the plates 142 were grounded; this can aid the transmission of the high-energy ion beam across the plasma channel 141. In one or more embodiments, separators may be positioned between portions of adjacent plates 142. For example, the separators may comprise a boron nitride spacer (not shown) most proximate to the plasma channel 141, a Viton O-ring surrounding the boron nitride spacer, and a PVC spacer surrounding the Viton O-ring.

Referring still to FIGS. 2A-4, the cathode housing 150 is configured to support a plurality of cathodes 151, for example, four cathodes, three cathodes, or two cathodes. In embodiments where the cathode housing 150 is configured to support four cathodes, the cathodes 151 may be positioned about 90° from one another in the cathode housing 150. In embodiments where the cathode housing 150 is configured to support three cathodes, the cathodes 151 may be positioned about 120° from one another, and in embodiments where the cathode housing 150 is configured to support two cathodes, the cathodes 151 may be positioned about 180° from one another. The cathode housing 150 also comprises a cathode target region 153 the is fluidly coupled to the target chamber 160 and in which the target gas housed in the target chamber 160 is also present. Each cathode 151 comprises a cathode needle 152 that extends from the cathode 151 into the cathode target region 153. Measurement of electric potential for each cathode 151 and each electrically isolated cooling plate 142 is done through a resistor network that will scale the full output to a data acquisition board level (0-10 volts). The current supplied to each cathode 151 will be measured by independent DC current monitors. These measurements help identify how much power, as well as the currents and potentials, is necessary to scale the plasma window to the desired parameters. As described in more detail below, the plasma window 140, including the cathodes 151 of the plasma window 140 may be modified, for example, for use in a beam accelerator system having multiple beamlines.

In operation, the cathodes 151 apply a voltage (e.g., a voltage in a range of from 150 V to 250 V, such as 200V) across multiple points in the cathode target region 153 via the cathode needles 152 to initiate and/or maintain the heating and ionization of a portion of the target gas thereby forming the plasma 105. The plasma 105 may comprise a well stabilized DC vacuum arc plasma formed within the plasma channel 141. Without intending to be limited by theory, the vacuum arc originates from the cathodes 151, which may comprise thoriated (e.g., 1-5% thorium, such as 2% thorium) tungsten cathodes. The integration of a small amount of thorium into tungsten allows it to maintain the refractory material properties of the tungsten of the cathodes 151 while reducing the work function of the material to generate much stronger thermionic emission than pure tungsten, increasing the lifetime and thermal efficiency of the cathodes 151.

In some embodiments, the cathodes 151 apply voltage to both initiate and maintain the formation of the plasma 105. However, other methods of initiating formation of the plasma 105 are contemplated, such as using one or more initiation coils, which may comprise resonant transformers, such as tesla coils, to apply the initial voltage. Such initiation coils, while not depicted, may be mounted on one or more of the plates 142 of the plasma window 140. Attaching the initiation coils to the plate 142 closest to the cathodes 151 will generate ions and electrons within the vacuum system, initiating the arc discharge from the cathodes 151 to the anode 130, thereby forming the plasma 105. Moreover, in embodiments comprising initiation coils, the cathodes 151 may still apply a voltage to maintain the plasma 105. The cathode target region 153 of the cathode housing 150 is fluidly coupled to the target chamber 160 by a gas inlet 154 and both the target chamber 160 and the cathode target region 153 operates at a significantly higher pressure than the anode 130 and the low-pressure chamber 120. The target chamber 160 and the cathode target region 153 may be pressurized by a pumping system or the like. It should be understood that, in some embodiments, the cathode target region 153 is a portion of the target chamber 160, that is, the portion of the target chamber 160 nearest the cathode needles 152.

Referring still to FIGS. 2A-4, the transmission of the high-energy ion beam from the anode 130 through the plasma window 140 to the cathode housing 150 will now be described. As mentioned above, the anode 130 may, in embodiments, be an anode plate comprising a nozzle 131 that is fluidly connected to the low-pressure chamber 120 and a channel 132 fluidly connected to the nozzle 131. The plasma window 140 includes a plurality of adjacent plates 142 having circular apertures coaxially aligned to form plasma channel 141. The plasma channel 141 is fluidly connected to the channel 132 of the anode 130 and the cathode target region 153 of the cathode housing 150. Target gas is introduced into the cathode target region 153 and the plasma 105 is generated at the cathode needles 152 (or at one or more initiation coils) and the plasma 105 fills the plasma channel 141 and extends into the channel 132 in the anode 130. Indeed, the plasma 105 is generated by applying a voltage to a target gas (which is housed in the target chamber 160 and the cathode target region 153 and may comprise deuterium, tritium, argon, or helium) thereby heating and ionizing a portion of the target gas to form the plasma 105. By filling the plasma channel 141 with the plasma 105, a pressure barrier is created between the cathode housing 150 and the anode 130. However, the charged particle beam 111 from the beam accelerator 110 (shown in FIG. 1) are capable of being transferred through the plasma 105. Therefore, the pressure differential between the high-pressure side of the beam accelerator system 100 and the low-pressure side of the beam accelerator system 100 can be maintained while still transmitting a high-energy ion beam through the beam accelerator system 100. The charged particle beam 111, which is generated by the beam accelerator 110, may be directed from the low-pressure chamber 120 through the plasma 105 disposed in the plasma channel 141 of the plasma window 140 and into the target chamber 160, where the charged particle beam 111 interacts with the target, such as the target gas, to produce neutrons via a fusion reaction.

The diameter of the aperture 410 in each plate 142 is approximately the size of the ion beam that is transmitted through the plasma channel 141. In embodiments, the aperture 410 has a diameter that is from 1 mm to 20 mm, such as from 3 mm to 15 mm, or from 4 mm to 10 mm, for example, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, or a value in a range having any two of these values as endpoints. In embodiments, the diameter of the aperture 410 may vary along the plasma window 140 to match the varying diameter of the plasma window 140. In such embodiments, the diameter of the aperture 410 is greater at one end of the plasma window 140 than at the opposite end. In operation, the aperture 410 simultaneously limits the loss of target gas and allows the ion beam to enter the target chamber 160. By including the plasma window 140, higher pressures, larger ion beams, and increased displacement rates are achievable. For example, by increasing the size of the aperture 410, the total beam current extracted from the ion source can be increased, facilitating an increase in extraction voltage, extraction beam current, target beam current, maximum beam diameter, and neutron yield. Indeed, The total neutron yield can be further increased by increasing the diameter of the aperture and reducing as flow in the beamline, facilitating increases in the beam current.

Without intending to be limited by theory, the pressure differential capabilities of the plasma window 140 are rooted in two fundamental principles. The first is the ideal gas equation:

$$P = \frac{ρ kT}{m}$$

where P is pressure, ρ is the mass density, k is the Boltzmann constant, T is the gas temperature, and m is the mass of gas particles. The plasma generated will create an area of high temperature within the aperture (on the order of 1.0×10⁴ K to 1.5×10⁴ K) which compensates the increased pressure of the high-pressure side of the plasma window. The second principle guiding plasma window operation is the Hagen-Poiseuille flow equation

$$Q = ( \frac{π {r}^{4} ρ}{8 η L} ) Δ P$$

where Q is the mass flow rate, r is the aperture radius, L is the channel length, η is the viscosity of the gas, and ΔP is the pressure difference (P₁-P₂). Due to the minimal length of the plasma window, <3 cm, incompressible flow is assumed. We can then write the following by combining equations X and Y above and assuming that

$${P}_{1} ≫ {P}_{2} P = \sqrt{\frac{8 k}{π m}} \sqrt{\frac{η TLQ}{{r}^{4}}} .$$

This equation, combined with the near-linear increase in deuterium viscosity with increase in temperature, shows that increasing the temperature within the aperture allows a large pressure differential to form across the plasma window.

There are many design and operational challenges associated with the implementation of the plasma window 140 in the beam accelerator system 100, for example, due to simultaneous increases in pressure differentials between the target chamber 160 and the low-pressure chamber 120, as well increases in the diameter of the aperture 410. In combination, these increases increase the attainable neutron generation of the beam accelerator system 100. Some of these challenges are described below together with design features contemplated to overcome such challenges.

One challenge in generating the plasma window 140 is the ability to generate and inject power into the system. Indeed, increasing pressure differentials between the target chamber 160 and the low-pressure chamber 120 not only requires more input power to the plasma window 140 but also increases the cathode potential. Likewise, maintaining a specific pressure while increasing aperture diameter also requires additional plasma window power and causes the cathode potential to drop. In each case, the cathode potential is set by the generated plasma arc and that to increase power there is only the option of increasing the current. Because of these factors, the power supplies chosen must be modular such that the necessary flexibility is in place to adapt them to the situation. Finally, it is preferable to have each cathode with fully independent power supplies to remove the potential of cross talk between them.

As described above, the plasma window 140 disclosed and described herein is effective at maintaining pressure differentials in the beam accelerator system 100, which can significantly reduce the costs (both capital and operating) and footprint associated with pumping systems needed in the beam accelerator system 100 that do not utilize one or more plasma windows 140. However, cooling a plasma window 140 once the plasma channel 141 fills with the plasma 105 is a challenge. In particular, it is conventional to use a constant power density on the plasma channel 141 regardless of the diameter of the plasma channel 141. However, as the diameter of the plasma channel 141 increases, the total power applied to the wall of the plasma channel 141 increases, causing extremely high temperatures. Accordingly, the plates 142 of the plasma window 140 may be designed to improve cooling of the plates 142 and the plasma channel 141. The wall-stabilization mechanism is, in part, predicated on the ability to have plasma-facing surfaces remain cool under operation. Without intending to be limited by theory, the wall-stabilization mechanism is the mechanism by which the plasma is stabilized and is a combination of two effects. First, the walls are cool and due to Spitzer resistivity, resistance has an inverse temperature relationship (cooler areas have higher resistance, hot areas have lower resistance). Thus, current will more easily flow through the regions of the plasma having low resistance which, in this case, is away from the walls. Second, the cooling plates are electrically isolated to prevent the current from simply travelling from the cathode to the anode along the plasma channel, instead of flowing with the feed gas. Without this, the plasma would be poorly confined leading to significant erosion and/or melting of metal components.

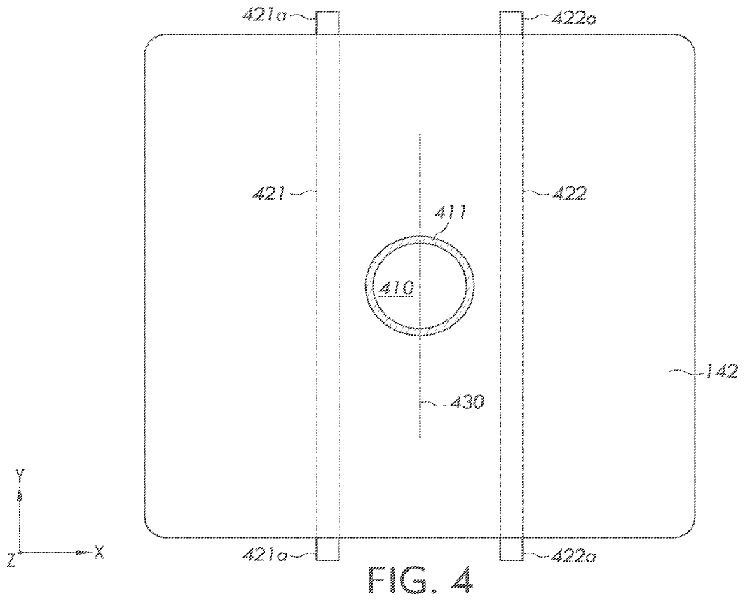

Referring now to FIG. 4, a front view of a plate 142 used in the plasma window 140 is schematically depicted. Most of the plate 142 is constructed from a thermally conductive metal, such as copper, silver, molybdenum, tungsten or related alloys. Additionally, the plate 142 can be a combination of materials. For example, a plate may consist of a largely copper body with a tungsten layer near the aperture 410. In operation, portions of the plasma 105 that fills the plasma channel 141 may contact the inner wall of the aperture 410. Because some thermally conductive metals traditionally used in industry, such as copper, may not be able to withstand the temperatures caused contact with—or even close proximity to—the plasma 105, a ring of refractory metal 411, such as tungsten or molybdenum, may be used to form the inner wall of the aperture 410 and, thereby the inner wall of the plasma channel 141. As the plasma window 140 is implemented into a location which will have limited access both physically and due to radioactivity, the lifetime of the materials used to create the plasma window 140 is important. The combination of thermally conductive metals with refractory metals leverages both the resistance of refractory metals to thermal damage and the high heat conduction of thermally conductive metals, together with the cooling techniques described below, minimize and can even prevent the formation of hot spots that can cause material ablation caused by insufficient confinement of the plasma.

To manage the heat load generated by the plasma 105 that fills the plasma channel 141, cooling channels 421 and 422 may be provided in the plate 142 near the aperture 410. A cooling fluid, such as deionized water or the like, is flushed through the cooling channels 421 and 422, thereby extracting heat from the portion of the plate 142 near the aperture 410 into the cooling fluid. While FIG. 4 depicts one cooling channel arrangement, other embodiments are contemplated, such as the cooling channel designs described in U.S. patent application Ser. No. 17/951,975, U.S. patent application Ser. No. 18/116,036, and U.S. patent application Ser. No. 18/144,675, each incorporated herein by reference in its entirety. During operation, inlet water temperature, return water temperature, and water flow rate are monitored using a resistance temperature detector (RTD). These measurements confirm that cooling water is flowing throughout the system and, measure temperature, and facilitate calculation of the amount of energy removed from the system by cooling.

Another challenge when operating the plasma window 140 is maintaining its stability during startup and operation. Should the plasma window 140 fail, issues could arise including the high-pressure release of tritium into the low-pressure regions causing radioactive contamination, overloading of the recirculation pumps, and neutron generation in unwanted areas where they may cause additional damage. Stability during the startup phase of plasma window operation is bolstered by the addition of a ballast resistor bank to each cathode 151. During startup and sometimes during normal operation, the arc operates in a negative resistivity regime which, if left unchecked, would cause the plasma 105 to burn itself out. The ballast resistors mediate the amount of current flowing through each cathode 151 allowing the plasma 105 to be continually generated. Contactors may be positioned across each resistor bank to allow them to be shorted. Once a certain level of current is being passed through each cathode 151, the operating regime no longer exhibits negative resistivity. Once the operating regime no longer exhibits negative resistivity, the contactors may be engaged to eliminate the potential drop and power consumption of the ballast resistor bank. Stability during the operational phase of the plasma window 140 is also aided by the addition of a series inductor to each cathode 151. In such embodiments, if a cathode 151 stops conducting during normal operation, the energy stored in the magnetic field of the inductor will cause the potential of that particular cathode 151 to spike, allowing the cathode 151 to re-ignite and continue conducting current.

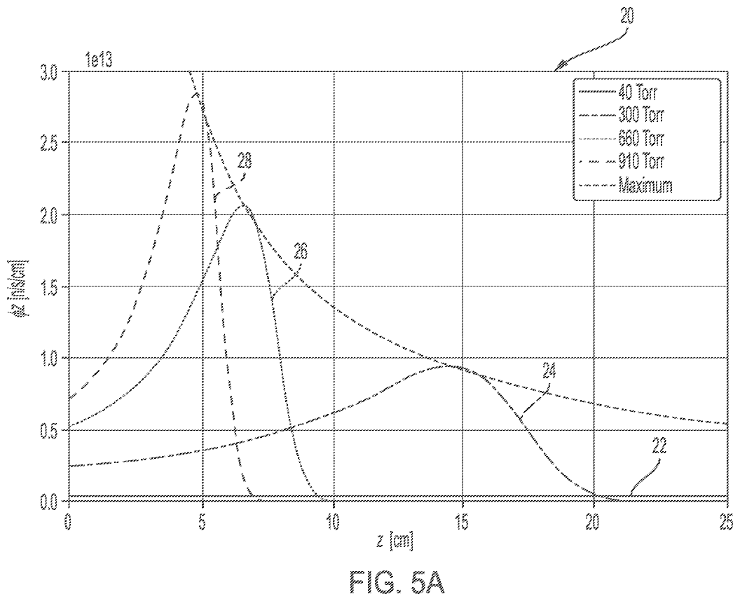

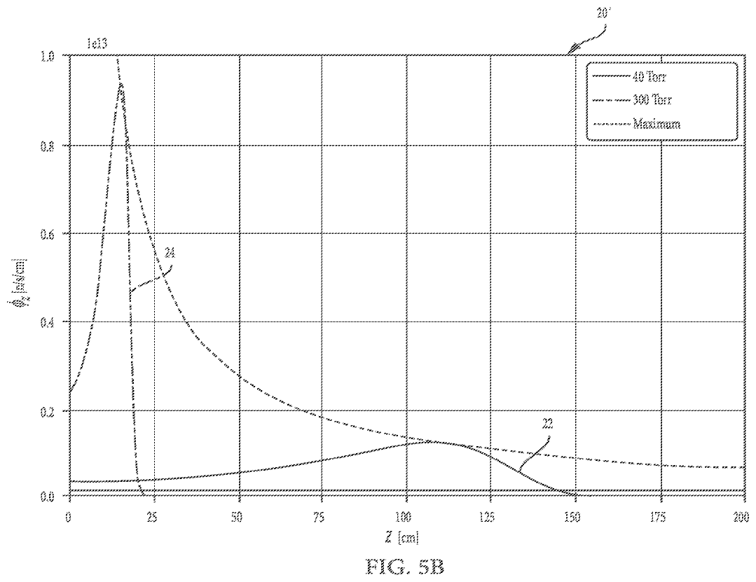

Referring now to FIG. 5A, graph 20 depicts a linear neutron source profile of neutrons generated using the beam accelerator system 100 of FIGS. 1-4 by a deuterium ion beam incident upon a tritium gas target at different target gas pressures. In particular, line 22 depicts the linear source profile for a 40 Torr target gas pressure, line 24 depicts the linear source profile for a 300 Torr target gas pressure, and line 26 depicts the linear source profile for a 660 Torr target gas pressure, and line 28 depicts the linear source profile for a 910 Torr gas pressure. FIG. 5B depicts graph 20′ of FIG. 5B shows graph 20 of FIG. 5A on a different scale to more clearly show lines 22 and 24.

Referring now to FIGS. 5A and 5B, the linear neutron source profiles shown by lines 22, 24, 26, and 28 are shaped as such because the incident ion beam loses energy as it slows down on the neutral gas in the target chamber. Thus, the cross section for fusion reactions (shown by Qz [n/s/cm] along the Y-axis of graph 20) vary as a function of distance in the target chamber (shown by z [cm] along the X-axis of graph 20). The DT fusion cross section has a maximum at about 113 keV resulting in the linear neutrons source profiles of lines 22, 24, 26 initially increasing until the beam energy slows to this value which then begins decreasing as the beam slows down further. As the target gas pressure (and hence density) increases, the beam slows down more quickly, which spatially compresses the linear neutron source source profile while keeping the total neutron source rate constant. Thus, when using gas target fusion as the basis for an FPNS, displacement rates can be increased by increasing the pressure in the target chamber.

Referring now to FIGS. 6A and 6B, a beam accelerator system 200 (FIG. 6A) and 200′ (FIG. 6B) comprising multiple beamlines (e.g., a first beamline and a second beamline) is depicted (each beamline comprising at least a beam accelerator and a low-pressure region, as describe above with respect to FIG. 1). As depicted in FIGS. 6A and 6B, the beamlines may be positioned end-to end, facing one another with a target chamber 260 (e.g., a central target chamber) positioned between the beamlines, the target chamber 260 comprising a first opening and a second opening. A first beamline of the beam accelerator system 200, 200′ comprises a first beam accelerator and a first low pressure region (e.g., a low pressure chamber). The first beam accelerator is configured to generate a first charged particle beam that enters the target chamber 260 through the first opening along a first beamline axis 202A. A second beamline of the beam accelerator system 200, 200′ comprises a second beam accelerator and a second low pressure region. The second beam accelerator is configured to generate a second charged particle beam that enters the target chamber 260 through the second opening along a second beamline axis 202B. A first plasma window assembly 240A is positioned at the first opening of the target chamber 260 to form an interface between the first beamline and the target chamber 260, thereby providing a pressure barrier between the target chamber 260 and the first low pressure chamber of the first beamline. A second plasma window assembly 240B is positioned at the second opening of the target chamber 260 to form an interface between the second beamline and the target chamber 260, thereby providing a pressure barrier between the target chamber and the second low pressure region.

The target chamber 260 may be surrounded by target cooling channels 262 and sample regions 265 (which may receive generated neutrons and may house a material for testing). As shown in FIG. 6A, the target cooling channels 262 may also be fluidly coupled to a cooling inlet 270 and a cooling outlet 172 to support the flow of a coolant, such as water or molten salt. As also shown in FIG. 6A, the target chamber 160 may also be fluidly coupled to a gas inlet 274 and a gas outlet 275 which support the introduction of tritium or another gas target into the target chamber 160, as well as the removal of unwanted gases, such as inert gases.

Each plasma window assembly 240A, 240B may comprise any of the plasma window embodiments described above with respect to FIGS. 1-4. For example, in each plasma window assembly 240A, 240B may comprise an anode 230A, 230B, a cathode pair 251A, 251B housed in a cathode housing 250A, 250B, and a plurality of plates 242A, 242B positioned between the anode 230A, 230B and the cathode pair 251A, 251B, wherein each plate 242A, 242B comprises an aperture that is aligned with an aperture in one or more adjacent plates to form a plasma channel. In some embodiments, the cathode pair 251A of the first plasma window assembly 240A is oriented orthogonal to the first beamline axis 202A. That is, a first cathode pair axis 255A (which approximately bisects the first cathode pair 251A lengthwise, passing through each cathode tip of the first cathode pair 251A) is orthogonal the first beamline axis 202A. Similarly, in some embodiments, the cathode pair 251B of the second plasma window assembly 240B is oriented orthogonal to the second beamline axis 202B. That is, a second cathode pair axis 255B (which approximately bisects the second cathode pair 251B lengthwise, passing through each cathode tip of the second cathode pair 251B) is orthogonal the second beamline axis 202B. This orthogonal arrangement provide advantages in embodiments of beam accelerator systems with spatial constraints. As shown in FIGS. 6A and 6B, the cathode pair 251A of the first plasma window assembly comprises a first cathode and a second cathode, the first cathode positioned radially opposite a second cathode with respect to the first beamline axis 202A. Similarly, the cathode pair 251B of the second plasma window assembly 240B comprises a first cathode and a second cathode, the first cathode positioned radially opposite a second cathode with respect to the second beamline axis 202B.

Referring now to FIG. 6B, in some embodiments, the anode 230A, 230B of one or both of the first and second plasma window assemblies 240A, 240B may be positioned between the between the target chamber 260 and the plurality of plates 242A, 242B such that the anode 230A, 230B is positioned proximate, for example, adjacent, the target chamber. The reverses the polarity of the plasma window assemblies 240A, 240B, and may provide advantages in embodiments of beam accelerator systems with spatial constraints.

Referring again to FIGS. 6A and 6B, including multiple beamlines and multiple plasma window assemblies in the beam accelerator system 200 further increases the DT neutron flux achievable in the central target chamber 260. For example, a two-beamline design of the beam accelerator system 200 with 10 cm long central target chamber 260 with a 50 cm³ sample volume produces mean displacement rates of 0.095 dpa/fpy and a helium production rate to displacement rate ratio of 18.3 appm/dpa. As used herein, “sample volume” refers to the volume of space available to place samples to be irradiated. The sample volume may be a space located outside of the central target chamber. In some embodiments, the sample volume is a single, continuous volume and in other embodiments, the sample volume is comprised of multiple, separate volumes that collectively add up to the total sample volume size.

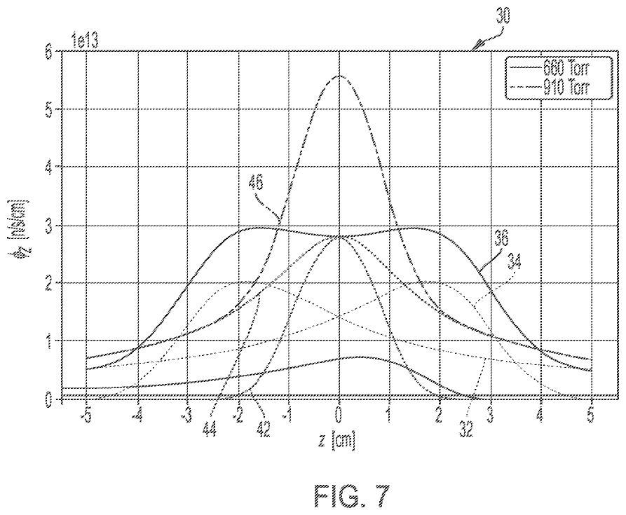

Referring now to FIG. 7, graph 30 depicts a linear neutron source profile of neutrons generated using the beam accelerator system 200 of FIG. 6 at target gas pressures of 660 Torr and 910 Torr. The linear neutron source profiles of graph 30 are shown on axis φz, which shows the cross section for fusion reactions (φ_{z} [n/s/cm] along the Y-axis of graph 30) as a function of distance in the target chamber (shown by z [cm] along the X-axis of graph 30, where z=0 represents the center of the target chamber). Lines 32 and 34 depict the individual beam contributions from the first and second beamlines at 660 Torr and line 36 shows their sum (e.g., the collective linear neutron source profile at 660 Torr). Lines 42 and 44 depict the individual beam contributions from the first and second beamlines at 910 Torr and line 46 shows their sum (e.g., the collective linear neutron source profile at 910 Torr). For the 910 Torr case, the peak from each beam is centered in the target chamber, which produces a sharp peak in their sum. For the 660 Torr case, the peak from each beam is about 2 cm off center, forming a broader plateau.

Results for peak and average values of key quantities over the sample volume are summarized in Table 2. Table 2 depicts peak and average values of key quantities at target pressures of 660 and 910 Torr and corresponds with the graphical data depicted in FIG. 7.

TABLE 2

| | | 660 Torr | | 910 Torr | |
|---|---|---|---|---|---|
| | | Peak | Average | Peak | Average |
| Neutron Flux | n/cm2/s | 1.08 × 10¹² | 1.02 × 10¹² | 1.21 × 10¹² | 1.10 × 10¹² |
| Displacement Rate | dpa/fpy | 0.092 | 0.088 | 0.104 | 0.095 |
| Helium Production | appm/fpy | 1.67 | 1.59 | 1.91 | 1.73 |

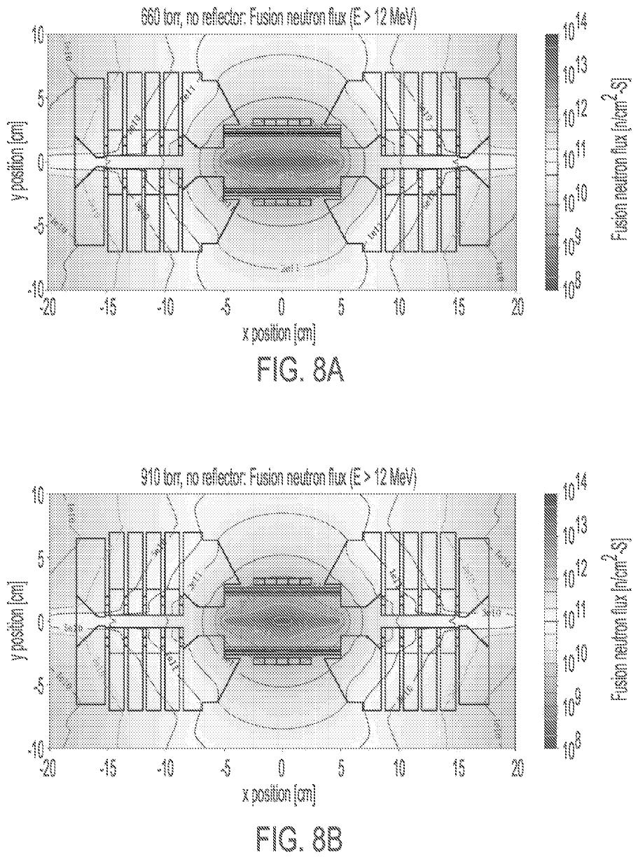

Referring now to FIGS. 8A and 8B, neutron flux maps corresponding to the data of graph 30 and Table 2 are shown. FIG. 8A depicts a neutron flux map at 660 Torr target pressure and FIG. 8B depicts a neutron flux map at 910 Torr. In both, the neutron flux at the inner wall of the target chamber is in a range of from 1×10¹² n/s to 3×10¹² n/s.

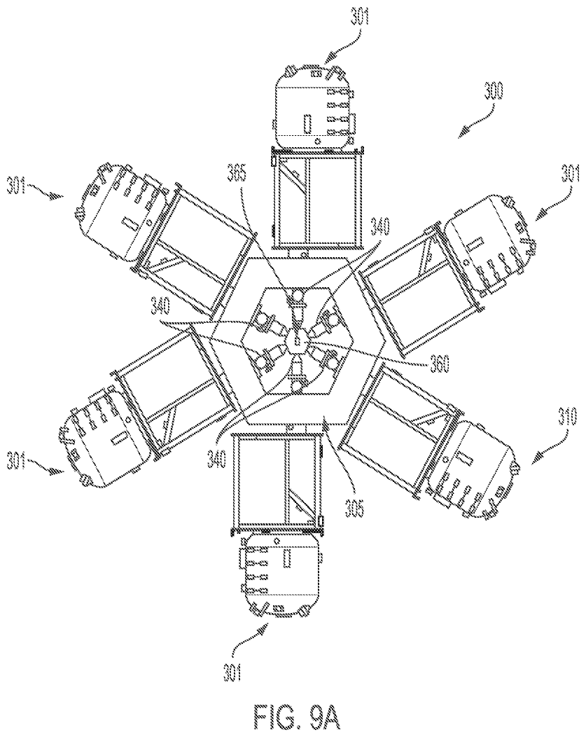

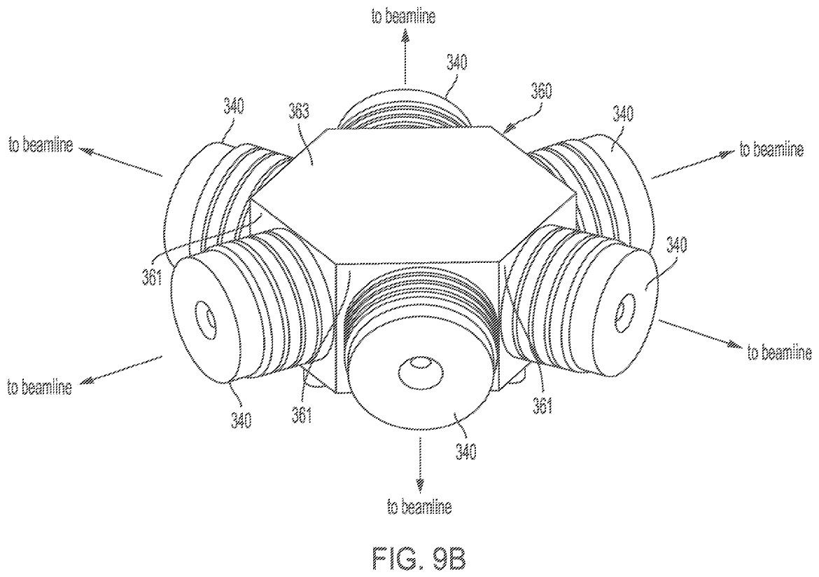

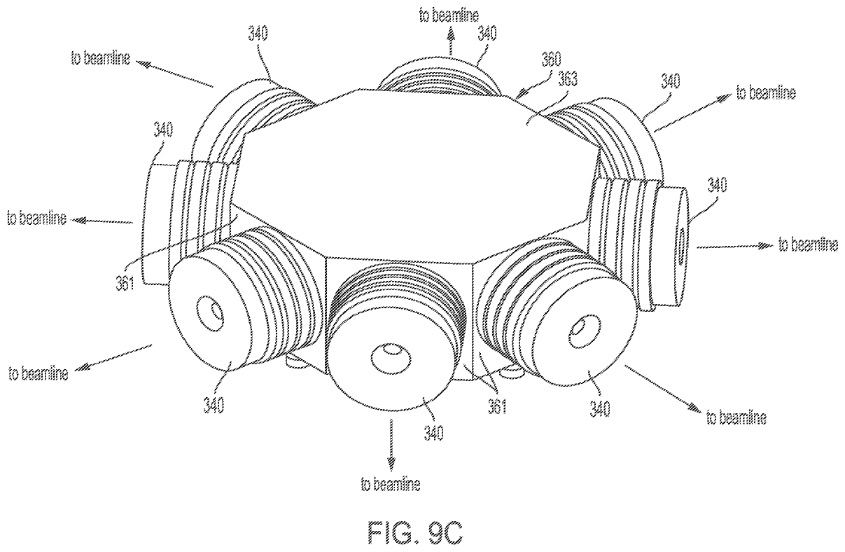

Referring now to FIGS. 9A-9C, a beam accelerator system 300 having three or more beamlines 301 is depicted (each beamline comprising at least a beam accelerator and a low-pressure region, as describe above with respect to FIG. 1). The beam accelerator system 300 is a multi-beam fusion system having a radial array of beamlines 301 surrounding a central target chamber 360, which may be a gas target of tritium. The beamlines 301 are radially arrayed around the central target chamber 360 (in a “wagon-wheel” arrangement) and all converge toward the central target chamber 360. The beam accelerator system 300 comprises a particle shield 305 surrounding the central target chamber 360 and positioned between the beam accelerators of each beamline 301 and central target chamber 360. The particle shield 305 is configured to block neutrons and protons that exit the central target chamber 360. In some embodiments, the particle shield 350 comprises concrete, a thermoplastic polymer, such as high-density polyethylene (HDPE), or combinations thereof. In FIGS. 9A and 9B, the beam accelerator system 300 comprises six beamlines and in FIG. 9C, the beam accelerator system 300 comprises eight beamlines, however, it should be understood that any number of beamlines 301 could be used with a single central target chamber 360.

The beam accelerator system 300 further comprises a plurality of plasma window assemblies 340 (one for each beamline 301) that form a pressure barrier between each individual beamline 301 and the central target chamber 360. That is, each plasma window assembly 340 operates as windowless vacuum barriers to separate the low-pressure beamlines 301 from the central target chamber 360. The beam accelerator system 300 may comprise three or more beamlines 301 and three or more corresponding plasma window assemblies 340. Each plasma window assembly 340 may comprise the plasma window 140 and corresponding anode and cathode(s) described above with respect to FIGS. 1-4. The central target chamber 360 may comprise a polygonal shape having a plurality of faces 361 (e.g., a polygonal prism shape) and a top surface 363. An individual plasma window assembly 340 may be is positioned in an opening of each of the plurality of faces 361 to form an interface between each beamline 301. While the central target chamber 360 is depicted as polygonal in FIGS. 9A-9C, it should be understood that embodiments are contemplated in which the central target chamber is cylindrical comprises a single, curved face in which a plurality of openings are positioned, each housing a plasma window assembly 340. Moreover, the central target chamber 360 comprises a top surface 363. In one example embodiment, each face 361 has a width of 10 cm and a height of 10 cm and the sample volume (e.g., a container housing a sample to be tested) is rectangular with 5 cm sides and a thickness of 1 cm. The sample volume may be placed at several heights above the beam plane. To achieve a sample volume of 50 cm³, samples could be placed both above and below the beam plane. While not depicted, the beam accelerator system 300 may further comprise a re-entrant cavity connected to the central target chamber 360, which could be used to place the samples into a higher flux region. The re-entrant cavity may extend into an outer surface of the central target chamber 360, for example, the top surface, forming a divot in the central target chamber 360 to provide a location for positioning samples closer to the generated neutrons.

Referring still to FIGS. 9A-9C, each plasma window assembly 340 may be radially positioned between the particle shield 305 and the central target chamber 360. The plasma window assemblies 340 allow for systems with an increased gaseous target pressure, a shortened target length and an increased current delivered to the target (e.g., a target gas present in the target chamber). Both the addition of multiple beam lines and the plasma windows lead to an increase in accessible neutron flux compared to traditional techniques. By using a single high-pressure neutron-generating gas target chamber 360, with multiple incident beamlines 301, the peak neutron flux and available irradiation volume (e.g., volume of a sample region 365) are both increased.

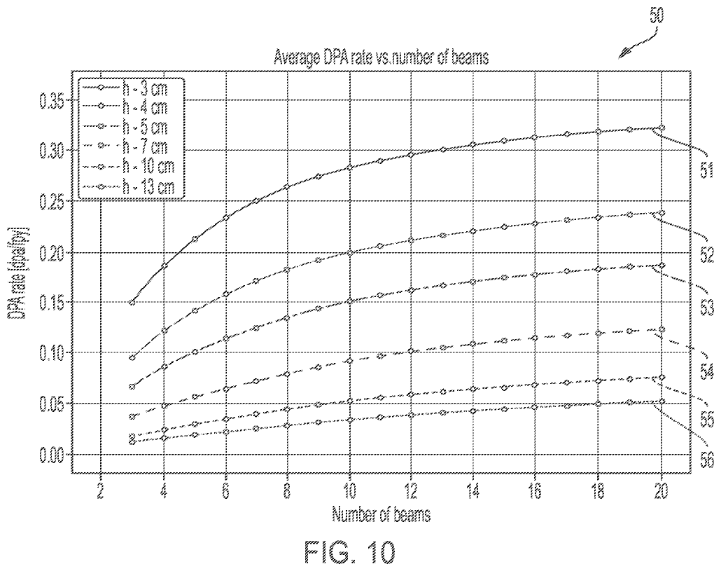

Referring now to FIG. 10, a graph 50 depicts the mean displacement rate as a function of number of ion beams entering the central target chamber 360 with distance above plane as a parameter. As used herein, “distance above plane” refers to a spatial offset in a direction orthogonal (e.g., an upward direction) to the propagation direction of each of the ion beams generated by the beamlines 301. Line 51 shows data for ion beams entering the central target chamber 360 with a distance above plane of 3 cm, line 52 shows data for beams entering the central target chamber 360 with a distance above plane of 4 cm, line 53 shows data for beams entering the central target chamber 360 with a distance above plane of 5 cm, line 54 shows data for beams entering the central target chamber 360 with a distance above plane of 7 cm, line 55 shows data for beams entering the central target chamber 360 with a distance above plane of 10 cm, and line 56 shows data for beams entering the central target chamber 360 with a distance above plane of 13 cm.

In the results depicted in FIG. 10, the hydrogen and helium production rates in the central target chamber 360 are directly proportional to the displacement rate. As shown in FIG. 10, three or more ion beams converging into the central target chamber 360 (e.g., polygonal prism shaped target chamber) on a parallel plane generates displacement rates in the range of 0.1 dpa/fpy to 0.3 dpa/fpy are possible, depending on the number of beams and sample height above the beamline (e.g., the distance above plane). Mean displacement rates up to 0.324 dpa/fpy and peak displacement rates of 0.358 dpa/fpy are achievable with twenty beamlines.

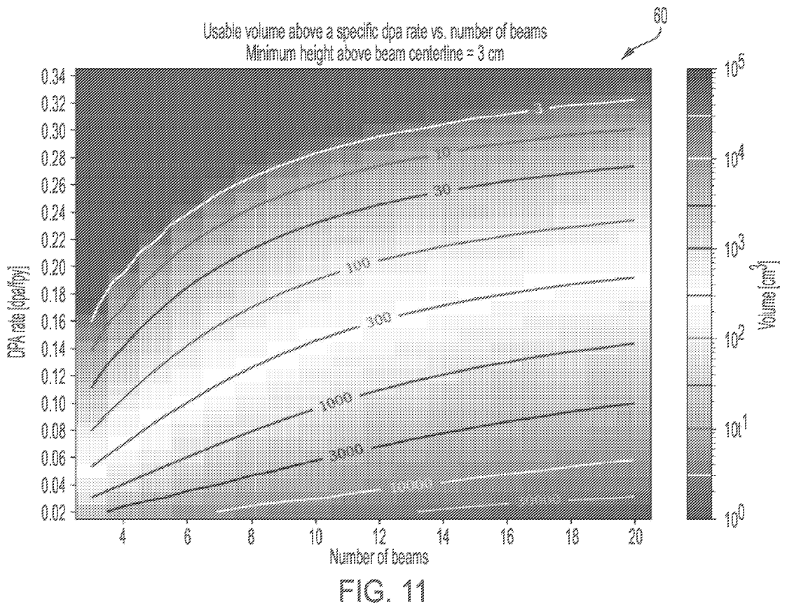

Referring now to FIG. 11, graph 60 depicts the usable sample volume of the central target chamber 360 at a variety of displacement rates as a function of the number of ion beams for a single beam accelerator system 300. A minimum distance of 3 mm above the beam plane is assumed could be achieved by connecting a re-entrant cavity to the central target chamber 360. As depicted in FIG. 11, increasing the number of ion beams causes an increase in the sample volume available for specific displacement rates. For example, the use of a 12-beam system at 0.1 dpa/fpy would allow an increase of 2000% in usable sample volume as compared to the target of 50 cm². Depending on the use case, such a system could provide a path to large-scale testing of samples with the possibility of relaxed restrictions on the size and shape of samples to be tested.

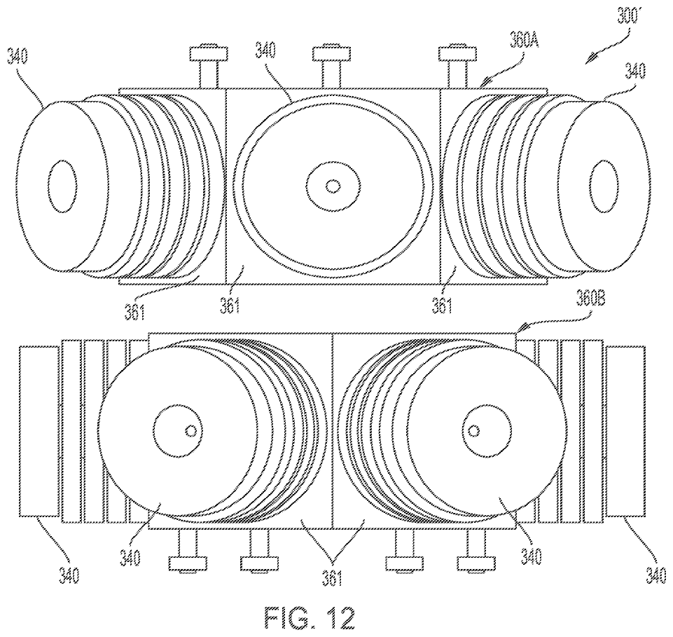

However, as shown in graphs 50 and 60 of FIGS. 10 and 11, respectively, the displacement rate experiences diminishing returns as the number of beamlines increases. Thus, instead of increasing the number of beamlines per system, it may be desirable to increase the number of overall systems. This would allow simultaneous experimentation on several types of material at a lower displacement rate. Indeed, FIG. 12 depicts such system. FIG. 12 schematically depicts a beam accelerator system 300′ depicted having two central target chambers 360A and 360B that are stacked together with a gap for testing samples in between the central target chambers 360A, 360B. To facilitate such a design, the beamlines that direct ion beams into each central target chamber 360A, 360B could be different beamline variants to accommodate the height difference but would otherwise still allow removal of an individual beamline for service using casters or a rail.

Referring now to FIGS. 9A-12, increasing displacement rate is also achievable by reducing the size of the central target chamber 360. Current plasma window hardware presents a challenge to reducing the size of the central target chamber 360 because positioning plasma window assemblies 340 in a radially arrayed beam system (such as the beam accelerator systems 300 and 300′) has geometric constraints, as each plasma window system is positioned near another because they surround the relatively small central beam target (that is, small in comparison to each beam system). To minimize the impact of these size constraints, a number of modifications to the plasma window assemblies are contemplated. For example, the plasma window assemblies may comprise two or less cathodes (i.e., two or one cathode), in contrast with the three or more cathodes present in standard configurations. For example, as shown in the embodiments of FIGS. 6A and 6B, a first cathode may be positioned radially opposite a second cathode with respect to a beam propagation direction of a corresponding beamline. For example, the cathodes may face toward the pathway of the ion beam (e.g., beamline axis) from opposite or near opposite directions, for example, above and below the pathway of the ion beam, allowing the plasma window assembled to be spaced closer together in a lateral direction. In such embodiments, the cathodes may also be oriented perpendicular to the beamline axis. As another example modification, in some embodiments the cathodes of the plasma window assemblies are bent tip cathodes, facilitating the positioning of a body of each bent tip cathode orthogonal or nearly orthogonal the beamline axis, while retaining the cathode tip at a lower angle (e.g., about 45 degrees) with respect to the beamline axis.

Moreover, in some embodiments, the polarity of the plasma window assembly may be reversed such that the cathodes are located further upstream (i.e., in a direction toward the beam accelerators of each beamline) where there is more physical space available due to the converging geometry of the beam accelerator system at the central target chamber. For example, as depicted in the embodiment of FIG. 6B, the anode of at least one of the plurality of plasma window assemblies may be positioned between the central target chamber and the plurality of plates of the plasma window assembly, such that the anode is positioned proximate the central target chamber. Because the anode has a smaller physical footprint than the cathodes and the cathode housing, reverse polarity plasma window assemblies could be spaced closer together around the central target chamber, facilitating a reduction in the volume of the central target chamber and/or an increase in the number of beamlines. Indeed, reducing the size of the plasma window by a factor of two increases the displacement rate between 8% (n=3) and 60% (n=20). Such reductions also facilitate an increased number of beamlines directed at the central target chamber 360, as the number of beamlines may limited in practice by the physical spacing and footprint of the plasma window assemblies.

In some embodiments, planar beamlines could be replaced by converging beams which also have some vertical component of travel, such that beamlines could direct ion beams into the central target chamber from all directions. While the manufacturability and maintainability of such a design would be reduced compared to the radially convergent “wagon wheel” type arrangement, in which ion beam propagate on a single plane to reduce engineering complexity, a spherically convergent arrangement could maximize the number of beamlines and neutron production.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. Thus it is intended that the specification cover the modifications and variations of the various embodiments described herein provided such modification and variations come within the scope of the appended claims and their equivalents.

As utilized herein, the terms “approximately,” “about,” “substantially”, and similar terms are intended to have a broad meaning in harmony with the common and accepted usage by those of ordinary skill in the art to which the subject matter of this disclosure pertains. Indeed, such terms refer to the subsequently listed property or measurement within normal manufacturing tolerances and imperfections in the relevant field. It should be understood by those of skill in the art who review this disclosure that these terms are intended to allow a description of certain features described and claimed without restricting the scope of these features to the precise numerical values or idealized geometric forms provided. Accordingly, these terms should be interpreted as indicating that insubstantial or inconsequential modifications or alterations of the subject matter described and claimed are considered to be within the scope of the disclosure as recited in the appended claims.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

1. A beam accelerator system comprising:
a plurality of beamlines each comprising a beam accelerator and a low pressure chamber, wherein the beam accelerator is configured to generate a charged particle beam;
a central target chamber coupled to each of the plurality of beamlines such that the plurality of beamlines direct charged particle beams into the central target chamber; and
a plurality of plasma window assemblies positioned in openings of the central target chamber to form an interface between each beamline and the central target chamber, thereby providing a pressure barrier between the central target chamber and each of the plurality of beamlines.

2. The beam accelerator system of claim 1, wherein the plurality of beamlines are arranged in a radial array around the central target chamber.

3. The beam accelerator system of claim 1, wherein the central target chamber is polygonal and comprises a plurality of faces, and the opening housing the plurality of plasma window assemblies are located in the plurality of faces.

4. The beam accelerator system of claim 1, wherein the plurality of beamlines comprise at least three beamlines and the plurality of plasma window assemblies comprise at least three plasma window assemblies.

5. The beam accelerator system of claim 1, wherein each plasma window assembly comprises:
an anode;
a cathode housing and at least one cathode positioned in the cathode housing; and
a plurality of plates positioned between the anode and the cathode housing, where each plate comprises an aperture that is aligned with an aperture in one or more adjacent plates to form a plasma channel.

6. The beam accelerator system of claim 5, wherein the at least one cathode comprises two or less cathodes.

7. The beam accelerator system of claim 5, wherein the at least one cathode comprises a first cathode and a second cathode, the first cathode positioned radially opposite the second cathode with respect to a beam propagation direction of a corresponding beamline.

8. The beam accelerator system of claim 5, wherein the at least one cathode comprises a bent tip cathode.

9. The beam accelerator system of claim 5, wherein the anode of at least one of the plurality of plasma window assemblies is positioned between the central target chamber and the plurality of plates such that the anode is positioned proximate the central target chamber.

10. The beam accelerator system of claim 5, wherein the cathode housing of at least one of the plurality of plasma window assemblies is positioned between the central target chamber and the plurality of plates such that the cathode housing is positioned proximate the central target chamber.

11. The beam accelerator system of claim 1, wherein the beam accelerator of each of the plurality of beamlines comprises an ion accelerator configured to generate an ion beam.

12. A method comprising:
generating plasma in a plasma channel of each of a plurality of plasma window assemblies, wherein each plasma window assemblies positioned in openings of a central target chamber; and
directing a plurality of ion beams generated along a plurality of beamlines through the plasma of the plurality of plasma window assemblies and into the central target chamber, wherein the central target chamber houses a target gas and each ion beam interacts with the target gas to produce neutrons via a fusion reaction, wherein:
each of the plurality of beamlines comprise an ion accelerator and a low pressure chamber;
the central target chamber is coupled to each of the plurality of beamlines by the plurality of plasma window assemblies; and
the plasma generated by each plasma window assembly forms an interface between the plurality of beamlines and the central target chamber, thereby providing a pressure barrier between the central target chamber and each of the plurality of beamlines.

13. The method of claim 12, wherein generating the plasma in the plasma channel comprises applying an input voltage to the target gas, thereby heating and ionizing a portion of the target gas to form the plasma.

14. The method of claim 12, further comprising impinging a sample volume with neutrons generated via the fusion reaction.

15. A beam accelerator system comprising:
a target chamber comprising a first opening and a second opening;
a first beamline comprising a first beam accelerator and a first low pressure chamber, wherein the first beam accelerator is configured to generate a first charged particle beam that enters the target chamber through the first opening along a first beamline axis;
a second beamline comprising a second beam accelerator and a second low pressure chamber, wherein the second beam accelerator is configured to generate a second charged particle beam that enters the target chamber through the second opening along a second beamline axis;
a first plasma window assembly positioned at the first opening of the target chamber to form an interface between the first beamline and the target chamber, thereby providing a pressure barrier between the target chamber and the first low pressure chamber; and
a second plasma window assembly positioned at the second opening of the target chamber to form an interface between the second beamline and the target chamber, thereby providing a pressure barrier between the target chamber and the second low pressure chamber, wherein:
the first plasma window assembly and the second plasma window assembly each comprise:
an anode;
a cathode pair;
a plurality of plates positioned between the anode and the cathode pair, wherein each plate comprises an aperture that is aligned with an aperture in one or more adjacent plates to form a plasma channel;
the cathode pair of the first plasma window assembly is oriented orthogonal to the first beamline axis; and
the cathode pair of the second plasma window assembly is oriented orthogonal to the second beamline axis.

16. The beam accelerator system of claim 15, wherein the cathode pair of the first plasma window assembly comprises a first cathode and a second cathode, the first cathode positioned radially opposite a second cathode with respect to the first beamline axis.

17. The beam accelerator system of claim 15, wherein the cathode pair of the second plasma window assembly comprises a first cathode and a second cathode, the first cathode positioned radially opposite the second cathode with respect to the second beamline axis.

18. The beam accelerator system of claim 15, wherein the anode of at least one of the first plasma window assembly and the second plasma window assembly is positioned between the target chamber and the plurality of plates such that the anode is positioned proximate the target chamber.

19. The beam accelerator system of claim 15, wherein the cathode pair of at least one of the first plasma window assembly and the second plasma window assembly is positioned in a cathode housing.

20. The beam accelerator system of claim 15, wherein the first beam accelerator and the second beam accelerator each comprise an ion accelerator and the first charged particle beam and the second charged particle beam each comprise an ion beam.
